(19) United States
(12) Patent Application Publication
(10) Pub. No.: US 2011/0151696 A1
(43) Pub. Date: Jun. 23, 2011

(54) Lockable Cable For Securing Fuse In A Loadbreak Elbow

(75) Inventors: Paul Michael Roscizewski, Eagle, WI (US); Mary Alice Park, New Berlin, WI (US)

(73) Assignee: Cooper Technologies Company, Houston, TX (US)

(21) Appl. No.: 12/641,085

(22) Filed: Dec. 17, 2009

(51) Int. Cl. H01R 13/53

(52) U.S. Cl. 439/187

(57) ABSTRACT

A loadbreak elbow includes a sleeve having an upper portion defining a fuse housing and a lower portion defining a cable entrance. A shield housing is positioned within the upper portion and includes a first opening for receiving a cable connector and second opening in communication with the first opening for receiving a fuse. A fuse is positioned in the second opening of the shield housing and a fuse ferrule is threadably coupled to the cable connector in the first opening. The cable connector includes a retaining feature, and the shield housing includes a retaining means to engage the retaining feature so as to prevent the cable connector from rotating within the shield housing while the fuse ferrule is being coupled to the cable connector.

### TECHNICAL FIELD

The present invention relates generally to loadbreak elbow connectors. More particularly, the present invention is directed to a loadbreak elbow connector that allows for simple installation of a fuse and without damage to an electrical cable.

### BACKGROUND OF THE INVENTION

Loadbreak elbows are typically used for making an electrical connection between a high voltage cable and a bushing on electrical power distribution equipment. The loadbreak elbows contain a fuse which is adapted to fit in a cable housing of the loadbreak elbow and engage a cable connector that is positioned within. Conventional loadbreak elbows have suffered from installation problems in the past because of the difficulty of aligning the fuse and the cable connector. Improper alignment or connection of the fuse to the cable may result in premature field failures and power outages due to high resistances from poor loose joints. In addition, because the cable housings are generally opaque, a user is unable to gauge when the fuse is adequately secured to the cable connector, and may continue providing too much torque when trying to secure the fuse to the cable connector, thus damaging the cable that is coupled to the cable connector. Once the cable and/or cable connector is damaged, significant and costly cable rework is incurred by the customer.

Therefore, a need exists for an improved loadbreak elbow that allows for proper alignment and engagement of a fuse with a cable connector, without causing damage to the cable.

### SUMMARY OF THE INVENTION

The present invention satisfies the above-described need by providing loadbreak elbows that allow for simple assembly and disassembly of the components for fuse replacement, without causing damage to the cable housed within.

In one embodiment, loadbreak elbows of the present invention include a molded rubber sleeve having an upper portion and a lower portion. The upper portion defines a fuse housing and the lower portion defines a cable entrance. A cable is positioned within the lower portion. The cable has a connector coupled to an end thereof. The connector has a fuse ferrule opening configured to mate with a fuse ferrule of a fuse. The connector also has a retaining feature. A shield housing is positioned within the upper portion. The shield housing includes a fuse opening in which a fuse is positioned, and a connector opening in which the connector is positioned. The fuse opening and the connector opening are in communication with each other. The connector opening has a retaining means therein for engaging and retaining the retaining feature of the connector. When the retaining feature properly engages the retaining means, the cable is unable to rotate within the connector opening in the shield housing. The retaining means has a non-circular cross-section, and the retaining feature has a non-circular cross-section corresponding to the non-circular cross-section of the retaining means. In some aspects, the cross-sections are hexagonal-shaped, include at least one flat side, or are asymmetric. In certain aspects, the retaining means includes a positive stop edge that prevents the connector from moving too far into the upper portion of the shield housing. The loadbreak elbow includes a fuse positioned in the upper portion of the shield housing, where the lower fuse ferrule of the fuse is threadably coupled to the fuse ferrule opening of the connector. A conductive tube can also be positioned at least partially within the upper portion of the sleeve, and extend out from the end of the sleeve opposite the cable. The fuse is positioned in the conductive tube and an elbow housing is coupled to the portion of the conductive tube extending from the end of the sleeve. To couple a probe housed within the elbow housing to the fuse, a probe adapter may be used.

In another embodiment, a cable connector of the present invention includes an upper portion and a lower portion. The upper portion has an opening having female threads therein for mating with male threads on a fuse ferrule of a fuse. The lower portion has a cable opening therein for receiving an end of a cable. The lower portion may be secured to the cable by crimping. The cable connector also includes a retaining feature coupled to the upper portion. The retaining feature may be positioned at an end of the upper portion adjacent the lower portion, at an end of the upper portion opposite the lower portion, or anywhere in between. The retaining feature has a non-circular cross-section, and may include at least one flat side or be asymmetric.

In yet another embodiment, a shield housing of the present invention includes an upper portion and a lower portion. The upper portion includes a fuse opening and the lower portion includes a connector opening. The fuse opening and the connector opening are in communication with each other. The connector opening includes a portion having a non-circular cross-section.

These and other aspects, objects, features, and embodiments of the present invention will become apparent to those having ordinary skill in the art upon consideration of the following detailed description of illustrative embodiments exemplifying the best mode for carrying out the invention as presently perceived.

### BRIEF DESCRIPTION OF THE DRAWINGS

FIG. 1A is a side view of a connector for a loadbreak elbow, according to an exemplary embodiment.

FIG. 1B is a side cross-sectional view of the connector of FIG. 1A, according to an exemplary embodiment.

FIG. 1C is a top view of the connector of FIG. 1A, according to an exemplary embodiment.

FIG. 1D is a side view of a cable coupled the connector of FIG. 1A, according to an exemplary embodiment.

FIG. 1E is a side cross-sectional view of the cable coupled the connector shown in FIG. 1D, according to an exemplary embodiment

FIG. 2A is a side view of a cable housing of a loadbreak elbow, with a cable inserted therein, according to an exemplary embodiment.

FIG. 2B is a side cross-sectional the cable housing of FIG. 2A, according to an exemplary embodiment.

FIG. 2C is a side cross-sectional view of a shield housing of the cable housing of FIG. 2A, according to an exemplary embodiment.

FIG. 3A is a side view of a fuse to be housed in a loadbreak elbow, according to an exemplary embodiment.

FIG. 3B is a perspective view of the fuse of FIG. 3A being coupled to a cable housing of a loadbreak elbow using a wrench, according to an exemplary embodiment.

FIG. 3C is a perspective view of the fuse of FIG. 3A being coupled to a cable housing of a loadbreak elbow using an allen wrench, according to an exemplary embodiment.

FIG. 3D is a side cross-sectional view of the fuse of FIG. 3A coupled to the cable housing of FIG. 3B, according to an exemplary embodiment.

FIG. 4A is a side view of a loadbreak elbow, prior to assembly, according to an exemplary embodiment.

FIG. 4B is a side cross-sectional view of the loadbreak elbow of FIG. 4A, according to an exemplary embodiment.

### DETAILED DESCRIPTION OF THE INVENTION

A loadbreak elbow, or electrical elbow, described herein includes a connector for coupling a cable to a fuse. Generally, the loadbreak elbow and cable connector have more longevity than existing loadbreak elbows in the market because the loadbreak elbow allows for insertion or replacement of the fuse without damage to the cable.

The invention may be better understood by reading the following description of non-limitative, exemplary embodiments with reference to the attached drawings wherein like parts of each of the figures are identified by the same reference characters.

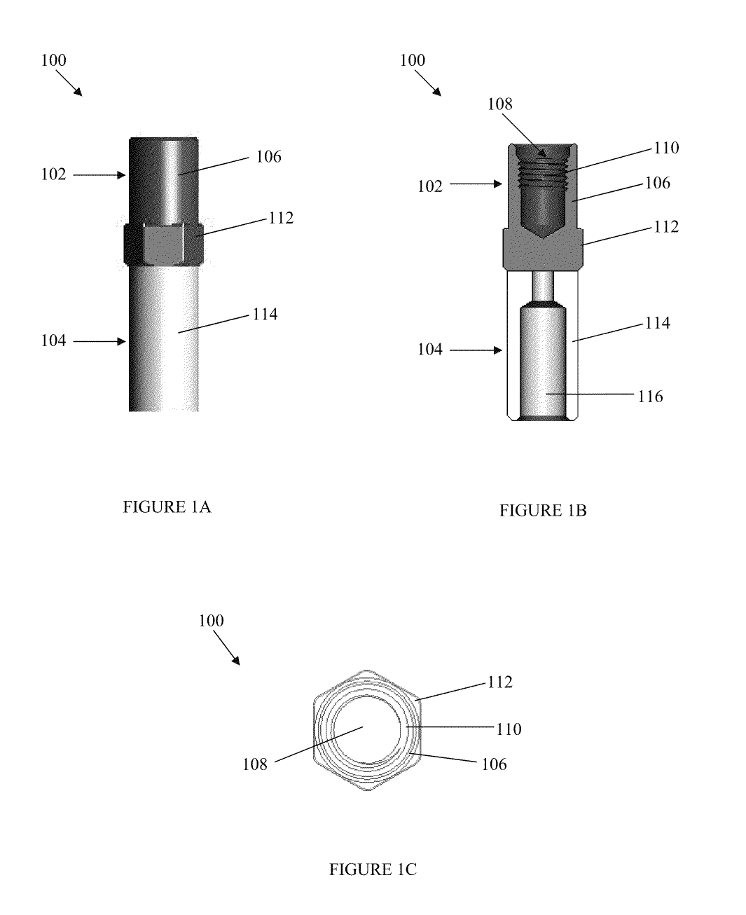

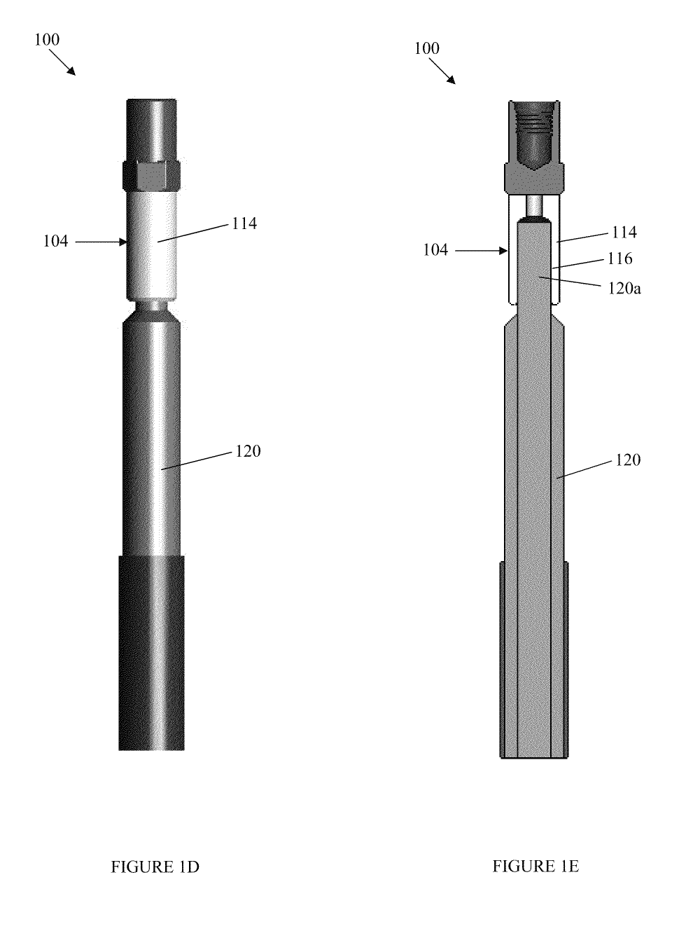

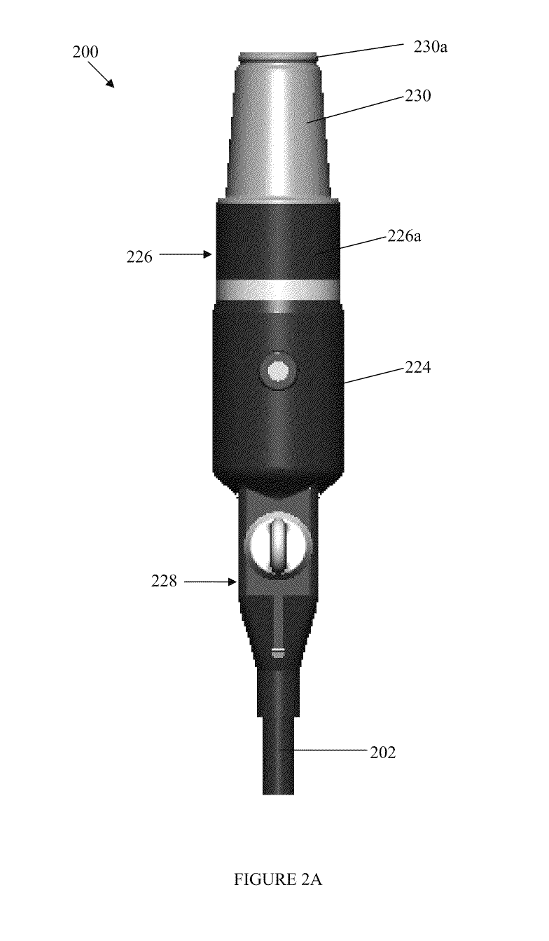

The first step in assembling a loadbreak elbow is to prepare a cable for insertion into a cable housing of a loadbreak elbow. The cable is prepared by inserting a conducting end of the cable into a connector and securing the cable to the connector. FIG. 1A is a side view of a connector 100, FIG. 1B is a side cross-sectional view of the connector 100, FIG. 1C is a top view of the connector 100, FIG. 1D is a side view of a cable 120 coupled to the connector 100, and FIG. 1E is a side cross-sectional view of a cable 120 coupled to the connector 100, according to an exemplary embodiment. Referring to FIGS. 1A-1C, the connector 100 includes an upper portion 102 and a lower portion 104. The upper portion 102 includes a cylindrical shaft 106 having an opening 108 therein. The opening 108 includes female threads 110 disposed therein. The connector 100 also includes a retaining feature 112 surrounding the shaft 106 of the upper portion 102. In certain exemplary embodiments, as shown in FIG. 1C, the retaining feature 112 has a hexagonal-shaped cross-section. The retaining feature 112 can be configured any number of ways so long as the retaining feature 112 includes a non-circular cross-section, such as a triangle, square, pentagon, or any other shape having a plurality of flat sides. In certain embodiments, the retaining feature 112 has a cross-section having two semi-circular sides separated by two flat sides positioned opposite each other. In other embodiments, the retaining feature 112 has an asymmetric cross-section having at least two flat sides. In certain exemplary embodiments, as shown in FIGS. 1A and 1B, the retaining feature 112 is positioned at an end of the shaft 106 adjacent the lower portion 104. In alternative embodiments, the retaining feature 112 may be positioned proximate to an end of the shaft 106 opposite the lower portion 104, or along any portion of the shaft 106. In certain exemplary embodiments, the upper portion 102 and the retaining feature 112 is constructed of copper, copper alloy, or aluminum.

Referring now to FIGS. 1A, 1B, 1D, and 1E, the lower portion 104 is a conducting end of the connector 100 and includes a cylindrical barrel 114. In certain exemplary embodiments, the barrel 114 is constructed of copper, copper alloy, or aluminum. The barrel 114 includes a cavity 116 therein. The cavity 116 is configured to receive an end 120a of the cable 120. In certain exemplary embodiments, to prepare the cable 120 for insertion into a cable housing of a loadbreak elbow, the end 120a of the cable 120 is positioned within the cavity 116 of the barrel 114, and the barrel 114 is crimped around the end 120a to secure the cable 120 to the connector 100.

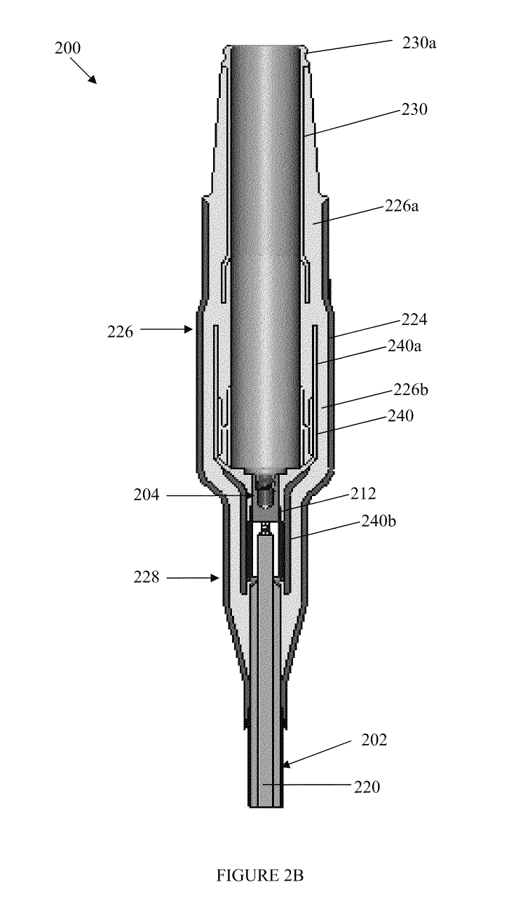

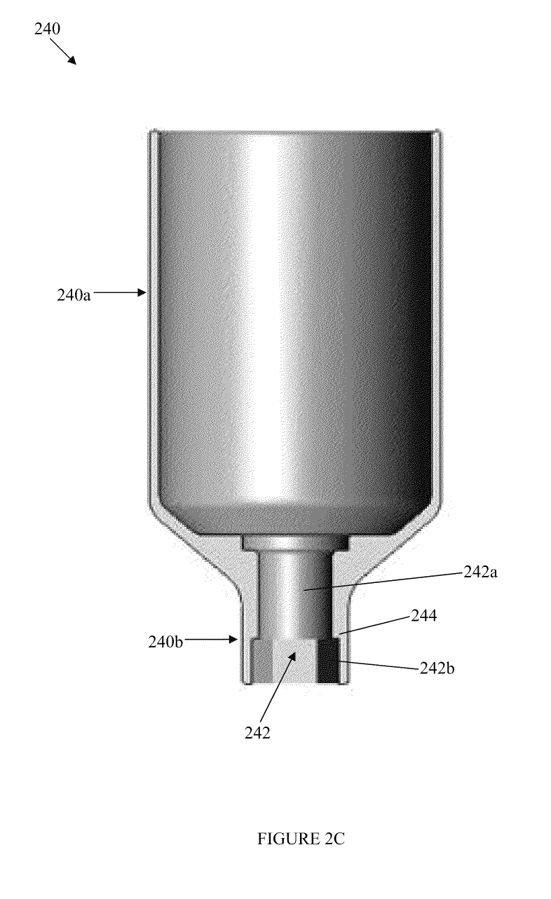

After the cable is prepared by securing it to a connector, the connector is inserted into a cable housing of a loadbreak elbow. FIG. 2A is a side view of a cable housing 200 of a loadbreak elbow having a prepared cable 202 inserted therein, and FIG. 2B is a side cross-sectional view of the cable housing 200 having the prepared cable 202 inserted therein, according to an exemplary embodiment. FIG. 2C is a side cross-sectional view of a shield housing 240 of the cable housing 200, according to an exemplary embodiment. Referring to FIG. 2B, the prepared cable 202 includes a connector 204, similar to the connector 100, coupled to a cable 220, similar to the cable 120. The connector 204 includes a retaining feature 212 having a hexagonal-shaped cross-section.

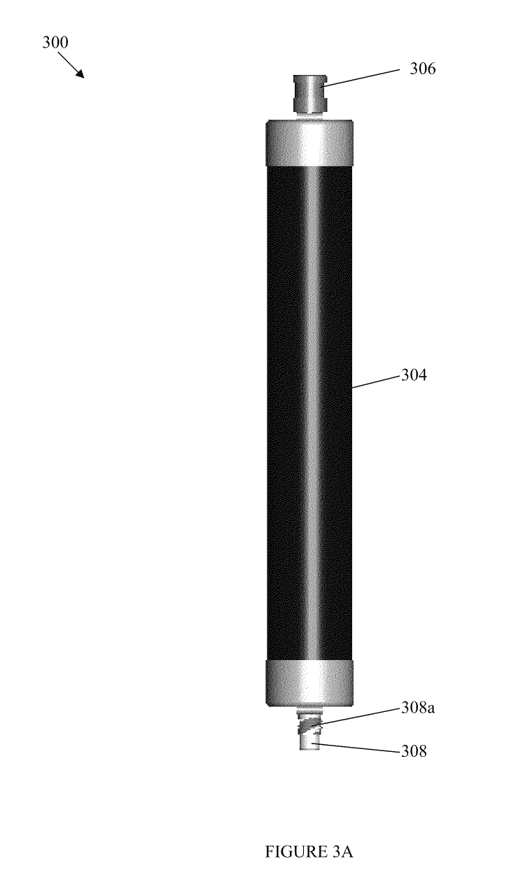

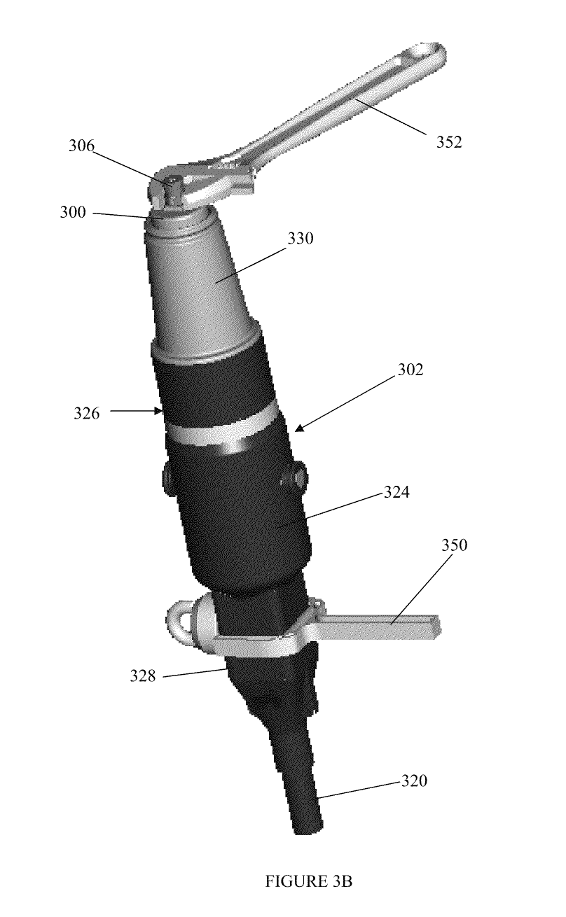

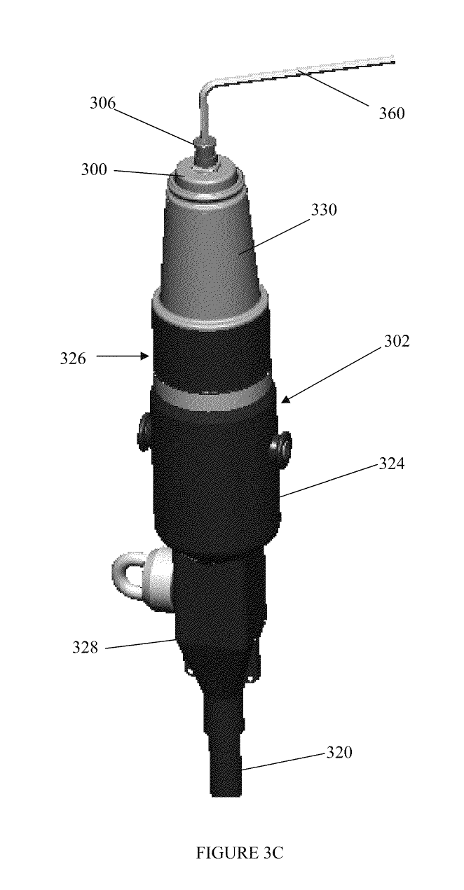

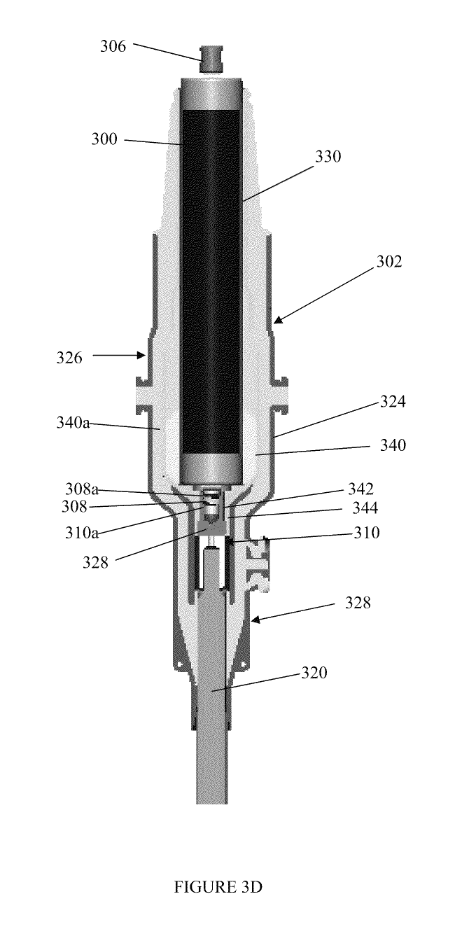

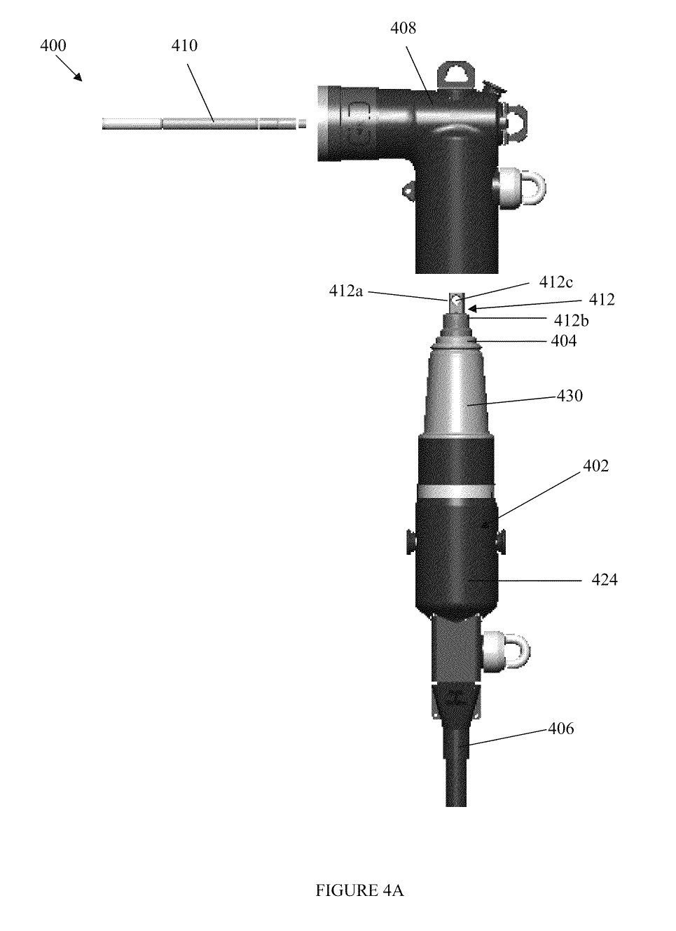

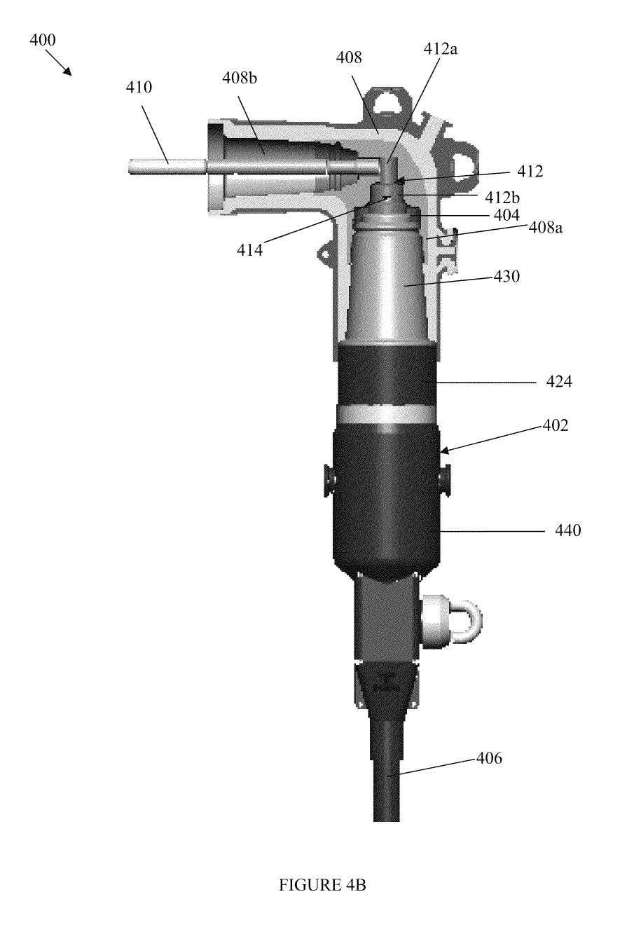

Referring now to FIGS. 2A-2B, the cable housing 200 includes a molded rubber sleeve 224 having a fuse housing portion 226 and a cable entrance portion 228. The cable entrance portion 228 has a sensitive inner diameter that is substantially sized to receive the cable 220 therein, whereby the cable entrance portion 228 is deformable or elastically expandable to substantially accommodate various cable diameters. In certain exemplary embodiments, the cable entrance portion 228 is rectangular-shaped and sized so as to allow an average-sized hand to grip the cable housing 200. In alternative embodiments, the cable entrance 228 can have any shape, such as cylindrical, hexagonal, and the like. A rigid conductive cylindrical tube 230 having a tapered end is positioned at least partially within an upper portion 226a of the fuse housing portion 226. The tube 230 is sized to receive a fuse 300 (FIG. 3A) therein. The tapered end of the tube 230 extends out of the sleeve 224, and is sized to mate with an elbow housing 408 (FIGS. 4A-4B) that is removable to allow access to the tube 230. In certain exemplary embodiments, the tube 230 includes a latching ring 230a on the end that extends out of sleeve 224. The latching ring 230a is configured to engage a rib of an elbow housing to ensure that bushing interfaces are properly sealed, and that the tube 230 is properly energized by making contact with the rib in the elbow housing. In certain exemplary embodiments, the tube 230 is constructed from any conductive material, such as a semi-conductive plastic, ethylene propylene diene monomer (EPDM), silicone, and the like.

Referring to FIGS. 2B-2C, the shield housing 240 is positioned in a lower portion 226b of the fuse housing portion 226. The shield housing 240 includes an upper portion 240a and a lower portion 240b. The upper portion 240a is cylindrical and has a diameter greater than a diameter of the tube 230 to provide electrical isolation of an upper fuse ferrule 306 (FIG. 3A) from a lower fuse ferrule 308 (FIG. 3A). In certain alternative embodiments, the shield housing 240 and the tube 230 may be replaced by a single tube having conductive paint painted on an upper and lower portion of the tube, where the upper and lower portions are separated from each other by a molded piece. The lower portion 240b includes an opening 242 sized to receive an upper shaft 206 and the retaining feature 212 of the connector 204 therein. In certain exemplary embodiments, the opening 242 includes a portion 242a having a circular cross-section sized to receive the upper shaft 206 of the connector 204, and a portion 242b having a hexagonal-shaped section sized to receive the retaining feature 212 of the connector 204 and prevent the connector 204 from rotating within. The opening 242 includes a positive stop edge 244 that prevents the retaining feature 212 from entering into the portion 242a having the circular cross-section. Thus, when the prepared cable 202 is inserted into the cable entrance portion 228, the retaining feature 212 of the connector 204 engages the portion 242b of the shield housing 240 and holds the cable 220 in place within the cable housing 200. In addition, the positive stop edge 244 also prevents the cable 220 from being pushed too far into the shield housing 240.

Once the prepared cable is fixed within the cable housing, the next step in assembling a loadbreak elbow involves coupling a fuse to the prepared cable. FIG. 3A is a side view of a fuse 300 to be housed in a loadbreak elbow, FIG. 3B is a perspective view of the fuse 300 being coupled to a cable housing 302 using a wrench 352, FIG. 3C is a perspective view of the fuse 300 being coupled to a cable housing 302 using an allen wrench 360, and FIG. 3D is a side cross-sectional view of the fuse 300 coupled to the cable housing 302, according to an exemplary embodiment. Referring to FIG. 3A, the fuse 300 includes a cylindrical fuse body 304, an upper fuse ferrule 306, and a lower fuse ferrule 308. The upper fuse ferrule 306 is configured to mate with a probe adapter probe adapter 412 (FIGS. 4A-4B). The lower fuse ferrule 308 includes male threads 308a, and is configured to mate with female threads 110 in the opening 108 of the connector 100 (FIG. 1B).

Referring now to FIGS. 3B-3D, the fuse 300 is inserted into the cable housing 302. The cable housing 302 is similar to the cable housing 200, and includes a molded rubber sleeve 324 having a fuse housing portion 326 and a cable entrance portion 328. A shield housing 340 is positioned within the fuse housing portion 326 adjacent the cable entrance portion 328. The shield housing 340 includes an opening 342 sized to receive a connector 310 therein. In certain exemplary embodiments, the opening 342 includes a positive stop edge 344. A cable 320 coupled to a connector 310 is positioned within the cable entrance portion 328, and is held in place by a retaining feature 312 positioned within the opening 342 and engaging the positive stop edge 344 of the shield housing 340.

A tube 330 having a cylindrical opening for receiving the fuse 300 is positioned at least partially within the fuse housing portion 326, and extends out of the sleeve 324. The fuse 300 is inserted into the tube 330 and an upper portion 340a of the shield housing 340 such that the upper fuse ferrule 306 extends out of the tube 330, and the lower fuse ferrule 308 is positioned within an opening 310a of the connector 310 having female threads therein. Referring to FIG. 3B, using a wrench 350 to hold the cable housing 302 in place, a user can use another wrench 352 to turn the fuse 300 via the upper fuse ferrule 306. In certain exemplary embodiments, the wrench 352 can be a specialized wrench that can allow a preferred torque, such as 12 foot pounds of torque, to be applied on the fuse 300. In certain embodiments, the wrench can be any wrench that engages the square portion on the need of the fuse. Referring to FIG. 3C, in certain exemplary embodiments, the allen wrench 360 engages the upper fuse ferrule 306 and can be turned at a determined torque to ensure adequate assembly of the fuse 300 to the connector 310. In certain embodiments, a user may grip the cable entrance portion 328 to hold the cable housing 302 in place, instead of using the wrench 350.

Referring again to FIGS. 3B-3D, as the fuse 300 is rotated, the male threads 308a of the lower fuse ferrule 308 also rotate and engage the female threads in the opening 310a of the connector 310. Since the retaining feature 312 holds the connector 310 in place, the forces from tightening the fuse 300 do not affect the conducting end of the cable 320, and therefore do not accidentally damage the cable 320. In addition, in the case that the cable 320 is not aligned properly or positioned far enough into the shield housing 340, the male threads 308a will not catch the female threads in the opening 310a of the connector 310, or if the male threads 308a do catch the female threads of the opening 310a, then the cable 320 will be pulled into the shield housing 340 until the retaining feature 312 engages the positive stop edge 344 in the opening 342 of the shield housing 340. In this case, the forces from tightening the fuse 300 still will not affect the conducting end of the cable 320.

After the fuse is inserted into the cable housing, the next step in assembling the loadbreak elbow involves coupling an elbow housing and a probe to the cable housing and the fuse. FIG. 4A is a side view of a loadbreak elbow 400 prior to assembly, and FIG. 4B is a side cross-sectional view of the assembled loadbreak elbow 400, according to an exemplary embodiment. The loadbreak elbow 400 includes a cable housing 402 having a tube 430 positioned at least partially within a rubber sleeve 424, and extending out from the sleeve 424. A fuse 404 is inserted into the tube 430 and a shield housing 440, and is coupled to a prepared cable 406 therein. The loadbreak elbow 400 also includes an elbow housing 408 having an L-shape coupled to the cable housing 402, and a probe 410 positioned within the elbow housing 408 and coupled to the fuse 404.

Once the fuse 404 is coupled to the prepared cable 406 within the cable housing 402, a probe adapter 412 is then secured to the fuse 404 to couple the probe 410 to the fuse 404. The probe adapter 412 includes an upper portion 412a and a lower portion 412b. The upper portion 412a includes an opening 412c configured to receive an end of the probe 410 therein. The lower portion 412b includes a cavity (not shown) that receives an upper fuse ferrule (not shown) of the fuse 404 therein. A set screw 414 is positioned within an opening (not shown) in a side wall of the lower portion 412b of the probe adapter 412. The set screw 414 holds the probe adapter 412 in place about the upper fuse ferrule of the fuse 404.

After the probe adapter 412 is in place, the elbow housing 408 is then coupled to the cable housing 402 by inserting the portion of the tube 430 extending out of the sleeve 424 into an opening 408a of the elbow housing 408. The probe 410 is then inserted into an opening 408b that is perpendicular to the opening 408a of the elbow housing 408. Finally, the end of the probe 410 is positioned within the opening 412c of the probe adapter 412. The loadbreak elbow 400 is then ready for the probe 410 to be connected to a bushing (not shown) on electrical power distribution equipment.

In the event that the fuse 404 in the loadbreak elbow 400 needs to be replaced. A user simply removes the probe 410 from the probe adapter 412 and disengages the elbow housing 408 from the tube 430. The probe adapter 412 is removed by removing the set screw 414 and sliding the probe adapter 412 off of the upper fuse ferrule of the fuse 404. Using a wrench (not shown) to hold the cable housing 402 in place, the user uses a second wrench to turn the fuse 404 via the upper fuse ferrule. As the fuse 404 rotates, male threads of a lower fuse ferrule 404b disengage female threads 406a in a connector 406b of the prepared cable 406 without damage to the cable 406b. Once the fuse 404 disengages the prepared cable 406, the fuse 404 can be slidably removed from the cable housing 402 and a new fuse (not shown) can be inserted therein and the loadbreak elbow 400 reassembled.

Furthermore, in the event that the connector 406b of the prepared cable 406 does not properly engage the shield housing 440, the fuse 404 is unable to engage the female threads 406a of the connector 406b. As a result, a user cannot assemble the fuse 404 within the cable housing 402, thus preventing possible premature field failures and power outages from improperly engaged fuses and connectors.

Therefore, the present invention is well adapted to attain the ends and advantages mentioned as well as those that are inherent therein. The particular embodiments disclosed above are illustrative only, as the present invention may be modified and practiced in different but equivalent manners apparent to those having ordinary skill in the art having the benefit of the teachings herein. Having described some exemplary embodiments of the present invention, it is believed that the use of alternate elbow housing, probe, connector, fuse, and tube configurations is within the purview of those having ordinary skill in the art. Additionally, while the present application generally illustrates loadbreak elbows having a two-piece housing having a cable housing and an elbow housing, loadbreak elbows having a three-piece housing having a cable housing, an elbow housing, and an additional fuse housing sleeve are within the purview of the invention.

While numerous changes may be made by those having ordinary skill in the art, such changes are encompassed within the spirit of this invention as defined by the appended claims. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. The terms in the claims have their plain, ordinary meaning unless otherwise explicitly and clearly defined by the patentee.

1. An apparatus comprising:
a loadbreak elbow for making an electrical connection between a cable and a loadbreak bushing of electrical power equipment, wherein the loadbreak elbow comprises
a sleeve having a fuse housing portion for receiving a fuse therein, and
a connector housing portion for receiving a cable connector therein, wherein the connector housing portion includes a retaining means for securing the connector therein, wherein the retaining means includes a non-circular connector opening cross-section, wherein the retaining means prevents the connector from rotating within the connector housing portion when the connector is positioned within the connector housing portion and engages the retaining means.

2. The apparatus of claim 1, further comprising said cable positioned within a cable entrance of the sleeve and having the connector coupled to an end thereof, the connector having a fuse ferrule opening for engaging a lower fuse ferrule of a fuse, the connector having retaining feature for engaging the retaining means of the connector opening.

3. The apparatus of claim 2, further comprising said fuse positioned in the fuse housing portion, wherein the lower fuse ferrule of the fuse is threadably coupled to the fuse ferrule opening of the connector.

4. The apparatus of claim 2, wherein the retaining feature includes a non-circular connector cross-section corresponding to the non-circular connector opening cross-section.

5. The apparatus of claim 4, wherein non-circular connector opening cross-section and the non-circular connector cross-section are hexagonal-shaped.

6. The apparatus of claim 4, wherein the non-circular connector opening cross-section and the non-circular connector cross-section include at least one flat side.

7. The apparatus of claim 4, wherein the non-circular connector opening cross-section and the non-circular connector cross-section are asymmetric.

8. The apparatus of claim 1, wherein the retaining means includes a positive stop edge that prevents the connector from entering the fuse housing portion.

9. The apparatus of claim 1, further comprising an elbow housing coupled to the sleeve.

10. An apparatus for securing a cable within a loadbreak elbow comprising:
a cable connector for engaging a connector housing portion of a loadbreak elbow sleeve of said loadbreak elbow, wherein the cable connector comprises
an upper portion having a threaded opening therein for mating with a threaded fuse ferrule;
a lower portion having a cable opening for housing an end of a cable therein; and
a retaining feature for engaging a retaining means of said connector housing portion of said loadbreak elbow sleeve, wherein the retaining feature is coupled to the upper portion, the retaining feature extending radially outward from the upper portion, wherein upon engagement of the retaining feature with the retaining means, the cable connector cannot rotate within the connector housing portion.

11. The apparatus of claim 10, wherein the retaining feature is positioned at an end of the upper portion adjacent the lower portion.

12. The apparatus of claim 10, wherein the retaining feature has a non-circular cross-section.

13. The apparatus of claim 12, wherein the non-circular cross-section includes at least one flat side.

14. The apparatus of claim 12, wherein the non-circular cross-section is asymmetric.

15. The apparatus of claim 14, further comprising said cable positioned within the cable opening in the lower portion and secured therein.

16. A loadbreak elbow comprising:
a fuse housing having an upper portion and a lower portion,
the upper portion having a fuse opening for receiving a fuse therein, and
the lower portion having a connector opening for receiving a cable connector therein, wherein the connector opening is in communication with the fuse opening, the connector opening having a retaining means for retaining a cable connector, wherein the retaining means has a non-circular cross-section, and wherein the retaining means prevents radial movement of the cable connector therein.

17. (canceled)

18. The loadbreak elbow of claim 16, wherein non-circular cross-section includes at least one flat side.

19. The loadbreak elbow of claim 16, wherein non-circular cross-section is asymmetric.

20. The loadbreak elbow of claim 16, wherein the connector opening includes a positive stop edge adjacent the retaining means that prevents axial movement of the cable connector in one direction.
